(19) United States
(12) Patent Application Publication
(10) Pub. No.: US 2024/0063376 A1
(43) Pub. Date: Feb. 22, 2024

(54) BULK SI-ANODE FOR USE IN PROTON-CONDUCTING RECHARGEABLE BATTERIES

(71) Applicant: KAWASAKI MOTORS, LTD., Hyogo (JP)

(72) Inventors: Kwohsiung YOUNG, Hyogo (JP); Yuko OZAKI, Hyogo (JP); Shinji SHIIZAKI, Hyogo (JP)

(73) Assignee: KAWASAKI MOTORS, LTD., Hyogo (JP)

(21) Appl. No.: 18/270,053

(22) PCT Filed: Dec. 29, 2020
(86) PCT No.: PCT/JP2020/049276

§ 371 Date: Jun. 28, 2023

(51) Int. Cl. H01M 4/38; H01M 4/134; H01M 10/0567

(52) U.S. Cl. CPC H01M 4/386; H01M 4/134; H01M 10/0567

(57) ABSTRACT

Provided are proton conducing rechargeable batteries that display excellent capacity. The rechargeable batteries include a cathode comprising a cathode electrochemically active material capable of storing and releasing hydrogen, optionally including Ni, and an anode, the anode including an anode electrochemically active material of one or more group 14 elements, the anode electrochemically active material in the powder form and associated by a binder, wherein a microstructure of the anode electrochemically active material is polycrystalline, a mixture of nanocrystalline and amorphous, or a combination of polycrystalline, nanocrystalline and amorphous. The cells include a non-aqueous electrolyte and are a characterized by a discharge capacity above 800 mAh/g of the anode electrochemically active material above 1 Volt.

### TECHNICAL FIELD

This disclosure relates to batteries, more specifically rechargeable batteries that cycle protons between the anode and the cathode in the generation of an electrical current that may be used to power one or more devices.

### BACKGROUND ART

The low equivalent weight alkali metals, such as lithium, render them particularly attractive as a battery component. Lithium provides greater energy per weight than previously used nickel and cadmium. An important challenge in the development of rechargeable lithium metal batteries, however, is effective cell cycling. On repeated charge and discharge, lithium “dendrites” are gradually produced on the surface of the lithium metal electrode. These may eventually grow to such an extent that they contact the cathode causing an internal short circuit in the battery, rendering the battery unusable after a relatively few cycles. Moreover, silicon that is commonly used as an anode material in lithium ion batteries due to very high theoretical specific capacity (4000 mAh/g), undergoes a dramatic volumetric lattice expansion when cycling with lithium. This expansion of as much as 400% further reduces cycle life and prevents the materials from being effectively used in many systems.

An alternative and attractive technology for rechargeable batteries relies on the cycling of the very low molecular weight hydrogen atom. It is known that some materials such as metal hydride alloys and nickel hydroxide are capable of absorbing and desorbing hydrogen. When paired with an appropriate anode material, these hydrogen storage materials can be employed in fuel cells and metal hydride batteries.

Silicon is also an attractive anode material in proton conducting batteries that it theoretically provides high gravimetric energy of hydrogen storage. The alkaline aqueous electrolyte typically used in these systems, however, is corrosive to silicon based materials making efforts at producing proton conducing rechargeable batteries employing Si as an anode active material difficult. Recently, new electrolyte materials have been attempted to allow the use of silicon based anode active materials. It was previously found, however, that the Si could only be used in thin film applications as increasing film thickness, e.g. above 250 nanometers, led to critical fracture stress, reduced capacity, and poor cycle life.

### SUMMARY OF INVENTION

### Technical Problem

As such, there is a need for improved proton conducting electrochemical cells that employ hydrogen storage materials and processes of their manufacture or activation. As will be explained herein below, the present disclosure addresses these needs by providing proton conducing electrochemical cells with nonaqueous electrolytes and silicon based anodes that exhibit excellent capacity so they may be effectively used in numerous electrochemical devices. These and other advantages of the disclosure will be apparent from the drawings, discussion, and description which follow.

### Solution to Problem

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole. The inventions as described herein are presented in the claims that follow.

Proton conducting batteries have numerous advantages including relatively low cost and improved safety profiles relative to lithium ion batteries. Among the challenges of proton conducing batteries has been improving capacity. Thus, addressing the needs of providing high capacity proton conducting battery systems is desirable. Provided herein are proton conducing batteries that employ Si anodes and for the first time demonstrate high discharge capacities above 1V of 800 mAh per gram of anode active material.

As such, provided are proton-conducting rechargeable batteries that include: a cathode with a cathode electrochemically active material capable of storing and releasing hydrogen; an anode, the anode including an anode electrochemically active material of one or more group 14 elements, the anode electrochemically active material in the powder form and associated by a binder, wherein a microstructure of the anode electrochemically active material is polycrystalline, a mixture of nanocrystalline and amorphous, or a combination of polycrystalline, nanocrystalline and amorphous; and a non-aqueous electrolyte in between the anode and the cathode; wherein a discharge capacity of the rechargeable battery is above 800 mAh/g of the anode electrochemically active material above 1 Volt vs. Ni(OH)₂ cathode.

In the above batteries, the anode active material may contain in some aspects, 1-3 different group 14 elements, optionally 2 group 14 elements, optionally 1 group 14 element. A group 14 element in an anode electrochemically active material is optionally Si. In some aspects, the anode active material contains no metals or metalloids other than one or more group 14 elements. Optionally, the anode electrochemically active material includes Si and one or more non-Si group 14 elements, optionally C, Ge or combinations thereof. The non-Si group 14 elements are optionally present at 50 atomic percent or less relative to the total group 14 elements in the anode electrochemically active material. In addition, in some aspects and anode electrochemically active material further includes one or more non-group 14 element containing hydrogen storage materials, optionally at 50 weight percent or less.

The batteries of either or both of the preceding two paragraphs may have a discharge capacity above 1000 mAh/g of anode electrochemically active material above 1 Volt, optionally above 1500 mAh/g above 1 Volt. In some aspects, a battery has a maximum discharge capacity of the rechargeable battery is above 3500 mAh/g of anode electrochemically active material.

The battery of any one or more of the preceding paragraphs optionally include a nonaqueous electrolyte that includes one or more aprotic compounds and acid(s) as proton source. The aprotic compounds may optionally include 1-butyl-3-methylimidazolium (BMIM), 1-ethyl-3-methylimidazolium acetate (EMIM), 1,3-dimethylimdiazolium, 1-ethyl-3-methylimidazolium, 1,2,3-trimethylimidazolium, tris-(hydroxyethyl)methylammonium, or 1,2,4-trimethylpyrazolium. The electrolyte may further include a proton conducting additive, a salt additive, or both. The salt additive optionally includes acetic acid. The salt additive optionally includes potassium. The electrolyte in any of the forgoing paragraphs of this section optionally include less than 10 ppm water.

In any of the aspects of any of the preceding paragraphs of this section optionally include a cathode with a cathode electrochemically active material that may include Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, a hydride thereof, an oxide thereof, a hydroxide thereof, an oxyhydroxide thereof, or any combination of the foregoing. In some aspects, the cathode electrochemically active material includes Ni at greater than or equal to 10 atomic percent relative to all metals in the cathode electrochemically active material, optionally at equal to or greater than 80 atomic percent, optionally 90 atomic percent. Optionally, the cathode electrochemically active material includes a hydroxide of Ni, Co, Mn, Zn, Al, or combinations thereof.

The cathode, anode, and electrolyte of any of the foregoing paragraphs are optionally presented in a housing. The anode and cathode are optionally separated by a separator. The anode includes an anode current collector, and the cathode includes a cathode current collector, whereby the anode current collector and the cathode current collector are electrically associated by one or more electron conducting conduits.

The proton conducting batteries are capable of achieving excellent capacity and dramatically pushing the technologies closer to theoretical maximums.

### BRIEF DESCRIPTION OF DRAWINGS

FIG. 1 illustrates an x-ray diffraction (XRD) pattern of a silicon sample used for an anode electrochemically active material according to some aspects as provided herein with a polycrystalline microstructure;

FIG. 2 illustrates an XRD pattern of a silicon sample used for an anode electrochemically active material according to some aspects as provided herein with a mixture of polycrystalline, nanocrystalline and amorphous Si;

FIG. 3 illustrates an XRD pattern of a silicon sample used for an anode electrochemically active material according to some aspects as provided herein with a nanocrystalline and amorphous microstructure;

FIG. 4 illustrates a test cell as used to characterize anode electrochemically active materials and electrolytes as provided herein;

FIG. 5 illustrates the discharge voltage profile at cycle 28 for sample 1 (polycrystalline Si) and sample 2 (mixture of polycrystalline, nanocrystalline and amorphous Si); and

FIG. 6 illustrates the discharge voltage profile at cycle 31 for sample 3 (nanocrystalline and amorphous Si).

### DESCRIPTION OF EMBODIMENTS

Provided are proton conducting rechargeable batteries that demonstrate excellent capacity. The provided proton conducting batteries do not require thin film anodes and thereby do not suffer film delaminations and corresponding capacity loss characteristic of prior Si containing anode electrochemically active materials. The batteries employ an anode with an anode electrochemically active material in powder form associated by a binder. This powder anode represents the first use of solid Si as a hydriding element in a proton conducting battery and providing the high capacities achieved. The batteries produce excellent discharge capacity in excess of 800 mAh/g of the anode electrochemically active material above 1 Volt vs. Ni(OH)₂ cathode by employing one or more group 14 elements with a microstructure of polycrystalline, amorphous, a mixture of nanocrystalline and amorphous, or a combination of polycrystalline, nanocrystalline and amorphous.

The proton conducting batteries as provided herein differ from traditional metal hydride batteries for many reasons including the absence of an aqueous electrolyte. This new generation of proton conducting batteries operate traditionally by cycling hydrogen between the anode and the cathode. The anodes thereby form a hydride of one or more elements in the anode during charge. This hydride is formed reversibly such that during discharge the hydride becomes the elemental portion of the anode electrochemically active material generating both a proton and an electron. The half reaction that takes place at the anode can be described as per the following half reaction:

M+H⁺+e⁻⇄MH [Chem.1]
where M as provided herein is or includes one or more group 14 elements.

The corresponding cathode reaction half reaction is typically:

M_{c}(OH)₂⇄M_{c}OOH+H⁺+e⁻ [Chem.2]
wherein M_{c} is any suitable metal(s) for use in a cathode electrochemically active material, optionally Ni.

As used herein, the term “battery” or “cell” may be used interchangeably. Optionally, a batter is a collection of two or more cells, wherein each cell may function as a proton conducting battery.

As used herein, an “anode” includes an electrochemically active material that acts as an electron acceptor during charge.

As used herein, a “cathode” includes an electrochemically active material that acts as an electron donor during charge.

As used herein, an “electrochemically active” material is one that includes one or more elements that are able to reversibly absorb a hydrogen ion.

When atomic percentages (at %) are presented and not otherwise defined, the atomic percentages are presented on the basis of the amount of all elements in the described material other than hydrogen and oxygen.

As such, provided herein are proton conducting electrochemical cells that include a cathode, an anode, and a non-aqueous electrolyte. The cells employ an anode with an anode electrochemically active material that includes one or more group 14 elements. Unlike prior thin film applications that are applied by chemical vapor deposition (CVD) or physical vapor deposition (PVD), the anode electrochemically active materials as provided herein according to some aspects, has a microstructure that is polycrystalline, a mixture of nanocrystalline and amorphous, or a combination of polycrystalline, nanocrystalline and amorphous.

An anode electrochemically active material optionally includes one or more group 14 elements. Group 14 elements include carbon (C), silicon (Si), germanium (Ge), tin (Sn), and lead (Pb). In some aspects, a group 14 element excludes Pb. Optionally, a group 14 element is C, Si, Ge, or any combination thereof. In some aspects, an anode electrochemically active material includes Si. Optionally, an anode electrochemically active material includes C. Optionally, an anode electrochemically active material includes Ge.

In some aspects, an anode electrochemically active material includes two or more group 14 elements. Optionally, an anode electrochemically active material includes two group 14 elements. Optionally, an anode electrochemically active material includes three group 14 elements. In some aspects, an anode electrochemically active material includes Si and C. Optionally, an anode electrochemically active material includes Si and Ge. Optionally, an anode electrochemically active material includes C and Ge. Optionally, an anode electrochemically active material includes Si, C, and Ge.

An anode electrochemically active material according to some aspects includes Si and one or more non-Si group 14 elements, optionally C and/or Ge. The non-Si group 14 elements are optionally present at 50 atomic percent or less relative to all group 14 elements in the anode electrochemically active material. Optionally, the non-Si group 14 elements are optionally present at 45 atomic percent or less, optionally 40 atomic percent or less, optionally 35 atomic percent or less, optionally 30 atomic percent or less, optionally 29 atomic percent or less, optionally 28 atomic percent or less, optionally 27 atomic percent or less, optionally 26 atomic percent or less, optionally 25 atomic percent or less, optionally 24 atomic percent or less, optionally 23 atomic percent or less, optionally 22 atomic percent or less, optionally 21 atomic percent or less, optionally 20 atomic percent or less, optionally 15 atomic percent or less, optionally 10 atomic percent or less, optionally 5 atomic percent or less, optionally 4 atomic percent or less, optionally 3 atomic percent or less, optionally 2 atomic percent or less, or optionally 1 atomic percent or less.

In some aspects, an anode electrochemically active material includes Si and Ge, wherein the Ge is present at 50 atomic percent or less relative to all group 14 elements in the anode electrochemically active material. Optionally, the Ge is present at 45 atomic percent or less, optionally 40 atomic percent or less, optionally 35 atomic percent or less, optionally 30 atomic percent or less, optionally 29 atomic percent or less, optionally 28 atomic percent or less, optionally 27 atomic percent or less, optionally 26 atomic percent or less, optionally 25 atomic percent or less, optionally 24 atomic percent or less, optionally 23 atomic percent or less, optionally 22 atomic percent or less, optionally 21 atomic percent or less, optionally 20 atomic percent or less, optionally 15 atomic percent or less, optionally 10 atomic percent or less, optionally 5 atomic percent or less, optionally 4 atomic percent or less, optionally 3 atomic percent or less, optionally 2 atomic percent or less, or optionally 1 atomic percent or less.

In other aspects, an anode electrochemically active material includes Si and C, wherein the C is present at 50 atomic percent or less relative to all group 14 elements in the anode electrochemically active material. Optionally, the C is present at 45 atomic percent or less, optionally 40 atomic percent or less, optionally 35 atomic percent or less, optionally 30 atomic percent or less, optionally 29 atomic percent or less, optionally 28 atomic percent or less, optionally 27 atomic percent or less, optionally 26 atomic percent or less, optionally 25 atomic percent or less, optionally 24 atomic percent or less, optionally 23 atomic percent or less, optionally 22 atomic percent or less, optionally 21 atomic percent or less, optionally 20 atomic percent or less, optionally 15 atomic percent or less, optionally 10 atomic percent or less, optionally 5 atomic percent or less, optionally 4 atomic percent or less, optionally 3 atomic percent or less, optionally 2 atomic percent or less, or optionally 1 atomic percent or less.

An anode electrochemically active material optionally includes SiₓM₁₋ₓ wherein M comprises one or more non-Si group 14 elements, and wherein 0<x<1. As described above, M is optionally C, Ge, or any combination thereof. Optionally, M is C. Optionally, M is Ge. Optionally, x is 0.5 or greater, optionally x is 0.55 or greater, optionally x is 0.6 or greater, optionally x is 0.65 or greater, optionally x is 0.7 or greater, optionally x is 0.71 or greater, optionally x is 0.72 or greater, optionally x is 0.73 or greater, optionally x is 0.74 or greater, optionally x is 0.75 or greater, optionally x is 0.76 or greater, optionally x is 0.77 or greater, optionally x is 0.78 or greater, optionally x is 0.79 or greater, optionally x is 0.8 or greater, optionally x is 0.85 or greater, optionally x is 9 or greater, optionally x is 0.95 or greater, optionally x is 0.96 or greater, optionally x is 0.97 or greater, optionally x is 0.98 or greater, or optionally x is 0.99 or greater.

It is appreciated that an anode electrochemically active material may include one or more other non-group 14 elements. Illustrative examples of non-group 14 elements include, but are not limited to lithium, boron, sodium, magnesium, and aluminum. Optionally, when a non-group 14 element(s) is present, the element is at 50 atomic percent or less, optionally 20 at % or less, optionally 10 at % or less, optionally 5 at % or less, optionally 4 at % or less, optionally 3 at % or less, optionally 2 at % or less, optionally 1 at % or less.

The Si component of the anode electrochemically active material is characterized by a microstructure. The microstructure of Si in an anode electrochemically active material is optionally polycrystalline, a mixture of nanocrystalline and amorphous, amorphous, or a combination of polycrystalline, nanocrystalline and amorphous. Optionally, a microstructure is not solely amorphous.

Optionally, a microstructure of the Si material in the anode electrochemically active material is or includes polycrystalline. Polycrystalline silicon is formed of multiple small silicon crystals or crystallites. The multiple crystallites are typically randomly arranged. Illustratively, polycrystalline Si may be obtained from any recognized commercial supplier, illustratively Wacker Chemi or Hemlock Semiconductor, among others.

Optionally, a microstructure of the Si in the anode electrochemically active material is a combination of nanocrystalline and amorphous. Nanocrystalline silicon is a form of silicon with a paracrystalline structure that typically includes an amorphous phase, but the nanocrystalline silicon differs from amorphous Si in that the nanocrystalline silicon also includes grains of crystalline silicon within the amorphous phase. Typical sources of nanocrystalline silicon include Strem (USA) and Cenate (Norway).

In some aspects, a microstructure of the Si in the anode electrochemically active material is a combination of polycrystalline, nanocrystalline and amorphous. When polycrystalline Si is present in a mixture of other microstructure silicon(s), the percentage (mass) of polycrystalline phase is 20 percent or less. Optionally, the percentage of polycrystalline Si is 15 percent or less, optionally 10 percent or less, optionally 5 percent or less.

An anode electrochemically active material optionally includes one or more non-group 14 element containing hydrogen storage materials. If a non-group 14 element containing hydrogen storage material is present in an anode electrochemically active material, the non-group 14 element containing hydrogen storage material is optionally present at 50 weight percent or less. Optionally the non-group 14 element containing hydrogen storage material is present at 40 weight percent or less, optionally 30 weight percent or less, optionally 20 weight percent or less, optionally 10 weight percent or less, optionally 5 weight percent or less, optionally 3 weight percent or less, optionally 20 weight percent or less, optionally 1 weight percent or less, optionally 0.1 weight percent or less, optionally 0.01 weight percent or less.

Illustrative examples of a non-group 14 element containing hydrogen storage material that may be included in an anode electrochemically active material include any material known in the art as capable of electrochemically and reversibly storing hydrogen. Illustrative examples of such materials are the ABₓ class of hydrogen storage materials where A is a hydride forming element, B is a non-hydride forming element and x is from 1-5. Illustrative examples include the AB₂, AB₅, and A₂B₇ type materials as they are known in the art. A hydride forming metal component (A) optionally includes but is not limited to lanthanum, cerium, praseodymium, neodymium, promethium, samarium, yttrium, or combinations thereof or other metal(s) such as a mischmetal. A B (non-hydride forming) component optionally includes a metal selected from the group of aluminum, nickel, cobalt, copper, and manganese, or combinations thereof. In some aspects, ABₓ type materials that may be further included in an anode electrochemically active material are disclosed, for example, in U.S. Pat. Nos. 5,536,591 and 6,210,498. Optionally, non-group 14 element containing hydrogen storage materials are as described in Young, et al., International Journal of Hydrogen Energy, 2014; 39(36):21489-21499 or Young, et al., Int. J. Hydrogen Energy, 2012; 37:9882. Optionally, non-group 14 element containing hydrogen storage materials are as described in U.S. Patent Application Publication No: 2016/0118654. In some aspects, a non-group 14 containing hydrogen storage material includes hydroxides, oxides, or oxyhydroxides of Ni, Co, Al, Mn, or combinations thereof, optionally as described in U.S. Pat. No. 9,502,715. Optionally, a non-group 14 containing hydrogen storage material includes a transition metal such as Ti, V, Cr, Mn, Fe, Co, Ni, Cu, Zn, Ag, Au, Cd, or combinations thereof, optionally as disclosed in U.S. Pat. No. 9,859,531.

The anode electrochemically active material is presented in a powder form, meaning that the anode electrochemically active material is a solid at 25 degrees Celsius (° C.) and free of any substrate. Despite prior belief to the contrary, it was found that solid group 14 elements may be used to form hydrides in the solid state and be useful for hydrogen storage or battery applications. The powder is held together by a binder that associates the powder particles in a layer that is coated on a current collector in the formation of an anode.

An electrochemical cell as provided herein also includes a cathode that houses a cathode electrochemically active material. A cathode electrochemically active material has the capability to absorb and desorb a hydrogen ion in the cycling of a proton conducting battery so that the cathode active material functions in pair with the anode electrochemically active material to cycle hydrogen and produce an electrical current. Illustrative materials suitable for use in a cathode electrochemically active material include metal hydroxides. Illustrative examples of metal hydroxides that may be used in a cathode electrochemically active material include those described in U.S. Pat. Nos. 5,348,822; 5,637,423; 5,366,831; 5,451,475; 5,455,125; 5,466,543; 5,498,403; 5,489,314; 5,506,070; 5,571,636; 6,177,213; and 6,228,535.

In some aspects, a cathode electrochemically active material includes a hydroxide of Ni alone or in combination with one or more additional metals. Optionally, an electrochemically active material includes Ni and 1, 2, 3, 4, 5, 6, 7, 8, 9, or more additional metals. Optionally, a cathode electrochemically active material include Ni as the sole metal.

Optionally, a cathode electrochemically active material includes one or more metals selected from the group of Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, a hydride thereof, an oxide thereof, a hydroxide thereof, an oxyhydroxide thereof, or any combination of the foregoing. Optionally, a cathode electrochemically active material includes one or more of Ni, Co, Mn, Zn, Al, Zr, Mo, Mn, a rare earth, or combinations thereof. In some aspects, a cathode electrochemically active material includes Ni, Co, Al, or combinations thereof.

A cathode electrochemically active material may include Ni. Ni is optionally present at an atomic percentage relative to the total metals in the cathode electrochemically active material of 10 atomic percent (at %) or greater. Optionally, Ni is present at 15 at % or greater, optionally 20 at % or greater, optionally 25 at % or greater, optionally 30 at % or greater, optionally 35 at % or greater, optionally 40 at % or greater, optionally 45 at % or greater, optionally 50 at % or greater, optionally 55 at % or greater, optionally 60 at % or greater, optionally 65 at % or greater, optionally 70 at % or greater, optionally 75 at % or greater, optionally 80 at % or greater, optionally 85 at % or greater, optionally 90 at % or greater, optionally 91 at % or greater, optionally 92 at % or greater, optionally 93 at % or greater, optionally 94 at % or greater, optionally 95 at % or greater, optionally 96 at % or greater, optionally 97 at % or greater, optionally 98 at % or greater, optionally 99 at % or greater. Optionally the sole metal in the cathode electrochemically active material is Ni.

An anode electrochemically active material, a cathode electrochemically active material, or both are optionally in a powder or particulate form. The particles may be held together by a binder to form a layer on a current collector in the formation of the anode or cathode. A binder suitable for use in forming an anode, a cathode or both is optionally any binder known in the art suitable for such purposes and for the conduction of a proton.

Illustratively, a binder for use in the formation of an anode includes but is not limited to polymeric binder materials. Optionally a binder material is an elastomeric material, optionally styrene-butadiene (SB), styrene-butadiene-styrene block copolymer (SBS), styrene-isoprene-styrene block copolymer (SIS) and styreneethylene-butadiene-styrene block copolymer (SEBS). Illustrative specific examples of a binder include, but are not limited to polytetrfluoroethylene (PTFE), polyvinyl alcohol (PVA), teflonized acetylene black (TAB-2), styrene-butadiene binder materials, or/and carboxymethyl cellulose (CMC). Illustrative examples may be found in U.S. Pat. No. 10,522,827. The ratio of electrochemically active material to binder is optionally from 4:1 to 1:4. Optionally, the ratio of electrochemically active material to binder is 1:3 to 1:2.

A cathode, anode or both may further include one or more additives intermixed with the electrochemically active materials. An additive is optionally a conductive material. A conductive material is optimally a conductive carbon. Illustrative examples of a conductive carbon include graphite. Other examples are materials that contain graphitic carbons, such as graphitized cokes. Still other examples of possible carbon materials include non-graphitic carbons that may be amorphous, non-crystalline, and disordered, such as petroleum cokes and carbon black. A conductive material is optionally present in an anode or a cathode at a weight percent (wt %) of 0.1 wt % to 20 wt %, or any value or range therebetween.

An anode or a cathode may be formed by any method known in the art. For example, an anode electrochemically active material or a cathode electrochemically active material may be combined with a binder, and optionally conductive material, in an appropriate solvent to form a slurry. The slurry may be coated onto a current collector and dried to evaporate some or all of the solvent to thereby form an electrochemically active layer on the surface of the current collector.

A current collector may be in the form of a mesh, foil, or other suitable form. Optionally, a current collector may be formed of aluminum, such as an aluminum alloy, nickel or nickel alloy, steel such as stainless steel, copper or copper alloys, or other such material. A current collector is optionally in the form of a sheet, and may be in the form of a foil, solid substrate, porous substrate, grid, foam or foam coated with one or more metals, or other form known in the art. In some aspects a current collector is in the form of a foil. Optionally, a grid may include expanded metal grids and perforated foil grids. A current collector is optionally formed of any suitable electronically conductive and optionally impermeable or substantially impermeable material, including, but not limited to copper, stainless steel, titanium, or carbon papers/films, a non-perforated metal foil, aluminum foil, cladding material including nickel and aluminum, cladding material including copper and aluminum, nickel plated steel, nickel plated copper, nickel plated aluminum, gold, silver, any other suitable electronically conductive and impermeable material or any suitable combination thereof. Optionally, a current collector may be formed of one or more suitable metals or combination of metals (e.g., alloys, solid solutions, plated metals). Optionally, a current collector for an anode includes or is exclusively steel such as stainless steel.

A proton conducing electrochemical cell may include a separator interposed between an anode and a cathode. A separator may be permeable to a hydrogen ion so as to not appreciably or unacceptably restrict ion transfer between the anode and the cathode. Illustrative examples of a separator include but are not limited to materials such as nylons, polyesters, polyvinyl chloride, glass fibers, cotton, among others. Illustratively, a separator may be polyethylene or polypropylene.

The proton conducting batteries as provided herein include a non-aqueous proton conducting electrolyte. The electrolyte is disposed between the anode electrochemically active material and the cathode electrochemically active material and allows the flow or other transfer of protons between the anode and the cathode. A nonaqueous electrolyte optionally includes less than 10 wt % water, optionally less than 5 wt % water, optionally less than 1 wt % water. In some aspects, a nonaqueous electrolyte includes less than 100 ppm water, less than 50 ppm water, optionally less than 10 ppm water.

The nonaqueous electrolyte optionally includes one or more aprotic compounds alone or in combination with one or more proton sources such as an organic acid. An aprotic compound is any compound suitable for use in an electrolyte and that is not otherwise detrimentally reactive with any other component of an electrochemical cell. Illustrative examples of an aprotic acid include ammonium or phosphonium compounds, optionally where the ammonium or phosphonium includes one or more linear, branched or cyclic substituted or non-substituted alkyl groups connected to a nitrogen or phosphorous.

A nonaqueous electrolyte optionally includes an ammonium or phosphonium compound with 1, 2, or more linear, branched or cyclic substituted or non-substituted alkyl groups bound to a positively charged nitrogen or phosphorus atom. Optionally, the compounds include one such alkyl, optionally two such alkyls that may be the same or different. Optionally, the ammonium or phosphonium compound alkyl is or includes 1-6 carbon atoms, optionally 1-4 carbon atoms and may be branched, linear or cyclic. In some aspects, the nitrogen or phosphorous is a member of a 5 or 6 membered ring structure that may have one or more pendant groups extending from the central ring. Optionally, ammonium ion is an imidazolium ion. Optionally, a phosphonium ion is a pyrrolidinium ion.

In some aspects, an ammonium or phosphonium includes 1 or 2 linear or cyclic, substituted or unsubstituted alkyls of 1-6 carbon atoms. Optionally, the alkyl includes 2, 3, 4, 5, or 6 carbons. In some aspects, the aprotic compound includes 1 or 2 alkyls of 1-6 carbons. A substitution in an alkyl is optionally a nitrogen, oxygen, sulfur, or other such element. Optionally, an ammonium or phosphonium includes a ring structure with 5-6 members where the ring is substituted with an N, an O, or P.

Illustrative examples of an aprotic compound for use as an electrolyte include, but are not limited to 1-butyl-3-methylimidazolium (BMIM), 1-ethyl-3-methylimidazolium (EMIM), 1,3-dimethylimdiazolium, 1-ethyl-3-methylimidazolium, 1,2,3-trimethylimidazolium, tris(hydroxyethyl)methylammonium, 1,2,4-trimethylpyrazolium, or combinations thereof.

The aprotic compound optionally includes one or more anions in conjunction with the aprotic compound. Illustrative examples of an anion include but are not limited to methides, nitrate, carboxylates, imides, halides, borates, phosphates, phosphinates, phosphonates, sulfonates, sulfates, carbonates and aluminates. Further illustrative examples may be found in U.S. Pat. Nos. 6,254,797 and 9,006,457. In specific exemplary aspects, an anion includes carboxylates such as an acetate, phosphates such as a hydrogen, alkyl, or fluorophospate, phophinates such as alkyl phosphinates, among others. Illustrative examples of such aprotic compounds include but are not limited to acetates, sulfonates, or borates of 1-butyl-3-methylimidazolium (BMIM), 1-ethyl-3-methylimidazolium (EMIM), 1,3-dimethylimdiazolium, 1-ethyl-3-methylimidazolium, 1,2,3-trimethylimidazolium, tris(hydroxyethyl)methylammonium, 1,2,4-trimethylpyrazolium, or combinations thereof. Specific examples include diethylmethylammonium trifluoromethanesulfonate (DEMA TfO), 1-ethyl-3-methylimidazolium acetate (EMIM Ac) or 1-butyl-3-methylimidazolium bis(trifluoromethylsulfonyl)imide (BMIM TFSI).

In addition to the aprotic compound, an electrolyte is optionally further supplemented with an organic acid that serves as a proton donor. The presence of the organic acid improves the overall proton conductivity of the electrolyte and thereby improves the function of the proton conducting battery employing the electrolyte. Optionally, an organic acid is a carboxylate. Illustrative examples of a carboxylate include those with 0-10 or more carbons attached to a terminal carboxylic acid. Specific illustrative examples include an acetic acid such as acetic acid or haloacetic acid (e.g. with 1-3 fluorine or chlorine atoms). Optionally an organic acid is acetic acid.

The organic acid is optionally present in the electrolyte at 1-5 moles/kg (m). Optionally, the organic acid is present at 3-4 m. Optionally, the organic acid is present at a concentration that is 3-3.5 m.

A nonaqueous electrolyte as used in any of the aspects as provided above or otherwise herein optionally includes one or more additives suitable to produce a maximum capacity of a proton conducting electrochemical cell housing the electrolyte to a discharge capacity of greater than 1000 mAh/g per weight of anode electrochemically active material. It was found that the addition of one or more suitable additives, such as a suitable salt, dramatically improves the formation of a proton conducting electrochemical cell as provided herein, and thereby improves the discharge capacity achievable by the cell. In the otherwise identical cell, it was found that the addition of one or more such additives could boost the maximum capacity, often by as much as 3-7 fold. Without being limited to one particular theory, it is believed that during formation, the availability of free hydrogen within the electrolyte varies to such an extent that cell formation is inhibited. The addition of a suitable salt stabilizes the free hydrogen concentration to thereby boost the resulting capacity achievable by the cell.

A salt additive suitable to produce a maximum capacity of a proton conducting electrochemical cell housing the electrolyte to a discharge capacity of greater than 1000 mAh/g per weight of anode electrochemically active material optionally includes those with a pKa in water of 1-14, optionally 3-13, optionally 7-13, optionally 3-8.

Illustrative examples of a salt additive suitable to produce a maximum capacity of a proton conducting electrochemical cell housing the electrolyte to a discharge capacity of greater than 1000 mAh/g per weight of anode electrochemically active material optionally includes salts of potassium or sodium. Suitable salts include phosphates, carbonates, or sulfates of potassium or sodium. Specific illustrative examples of potassium salts include, but are not limited to potassium phosphate such as mono- or dipotassium phosphate, potassium carbonate, potassium sulfate, among others. Illustrative examples of sodium salts include, but are not limited to sodium mono-, di-, tetra-phosphate, sodium bicarbonate, and sodium hydrogen sulfate.

The salt additive suitable to produce a maximum capacity of a proton conducting electrochemical cell housing the electrolyte to a discharge capacity of greater than 1000 mAh/g per weight of anode electrochemically active material may be present in an electrolyte at 0.01 to 1 m, optionally 0.01 to 0.2 m, optionally 0.5 to 1 m.

The anode, cathode, separator, and nonaqueous electrolyte may be housed in a cell case (e.g. housing). The housing may be in the form of a metal or polymeric can, or can be a laminate film, such as a heat-sealable aluminum foil, such as an aluminum coated polypropylene film. As such, an electrochemical cell as provided herein may be in any known cell form, illustratively, a button cell, pouch cell, cylindrical cell, or other suitable configuration. In some aspects, a housing in is in the form of a flexible film, optionally a polypropylene film. Such housings are commonly used to form a pouch cell. The proton conducting battery may have any suitable configuration or shape, and may be cylindrical or prismatic.

The current collector or substrates may include one or more tabs to allow the transfer of electrons from the current collector to a region exterior of the cell and to connect the current collector(s) to a circuit so that the electrons produced during discharge of the cell may be used to power one or more devices. A tab may be formed of any suitable conductive material (e.g. Ni, Al, or other metal) and may be welded onto the current collector. Optionally, each electrode has a single tab.

The resulting proton conducting batteries as provided herein in any aspect described optionally has a discharge capacity of the rechargeable battery above 800 mAh/g of the anode electrochemically active material above 1 Volt vs. Ni(OH)₂ cathode. Optionally, the discharge capacity is measured following cell formation, optionally at cycle 20, 21, 22, 23, 24, 25, 26, 27, 28, 29, or 30. The battery optionally has a discharge capacity at or in excess of 900 mAh/g as measured per above, optionally 1000 mAh/g, optionally 1100 mAh/g, optionally 1200 mAh/g, optionally 1300 mAh/g, optionally 1400 mAh/g, optionally 1500 mAh/g, optionally 1600 mAh/g, optionally 1700 mAh/g, optionally 1800 mAh/g, optionally 1900 mAh/g, optionally 2000 mAh/g.

In some aspects, a proton conducting battery as provided herein has a maximum capacity of or in excess of 1000 mAh/g where grams is the weight of the anode electrochemically active material and as measured against a Ni(OH)₂ cathode. Optionally, the maximum capacity, is or is in excess of 1100 mAh/g, optionally 1200 mAh/g, optionally 1300 mAh/g, optionally 1400 mAh/g, optionally 1500 mAh/g, optionally 1600 mAh/g, optionally 1700 mAh/g, optionally 1800 mAh/g, optionally 1900 mAh/g, optionally 2000 mAh/g, optionally 2500 mAh/g, optionally 3000 mAh/g, optionally 3500 mAh/g, optionally 4000 mAh/g, optionally 4500 mAh/g, optionally 5000 mAh/g, optionally 5500 mAh/g, optionally 6000 mAh/g, optionally 6500 mAh/g.

In particular aspects, an electrochemical cell as provided herein includes a cathode comprising a cathode electrochemically active material capable of storing and releasing hydrogen, an anode, the anode comprising an anode electrochemically active material of one or more group 14 elements, the anode electrochemically active material in the powder form and associated by a binder, wherein a microstructure of the anode electrochemically active material is polycrystalline, a mixture of nanocrystalline and amorphous, or a combination of polycrystalline, nanocrystalline and amorphous, and a non-aqueous electrolyte that includes an ammonium aprotic compound and a carboxylic acid additive, optionally where the anode electrochemically active material includes Si, and optionally includes one or more salt additives of potassium or sodium.

In other aspects, an electrochemical cell as provided herein includes a cathode comprising a cathode electrochemically active material comprising Ni, an anode, the anode comprising an anode electrochemically active material of Si and one or more non-Si group 14 elements, the anode electrochemically active material in the powder form and associated by a binder, wherein a microstructure of the anode electrochemically active material is polycrystalline, a mixture of nanocrystalline and amorphous, or a combination of polycrystalline, nanocrystalline and amorphous, and a non-aqueous electrolyte that includes an ammonium aprotic compound and a carboxylic acid additive, optionally where the anode electrochemically active material includes Si, and optionally includes one or more salt additives of potassium or sodium.

In some aspects, an electrochemical cell as provided herein includes a cathode comprising a cathode electrochemically active material including Ni as a predominant, an anode, the anode comprising an anode electrochemically active material of one or more group 14 elements, the anode electrochemically active material in the powder form and associated by a binder, wherein a microstructure of the anode electrochemically active material is amorphous, polycrystalline, a mixture of nanocrystalline and amorphous, or a combination of polycrystalline, nanocrystalline and amorphous, and a non-aqueous electrolyte that includes an ammonium aprotic compound and an acetic acid additive, optionally where the anode electrochemically active material includes Si as a predominant by atomic percentage, and optionally includes one or more salt additives of potassium as provided herein.

### EXPERIMENTAL

### Example 1

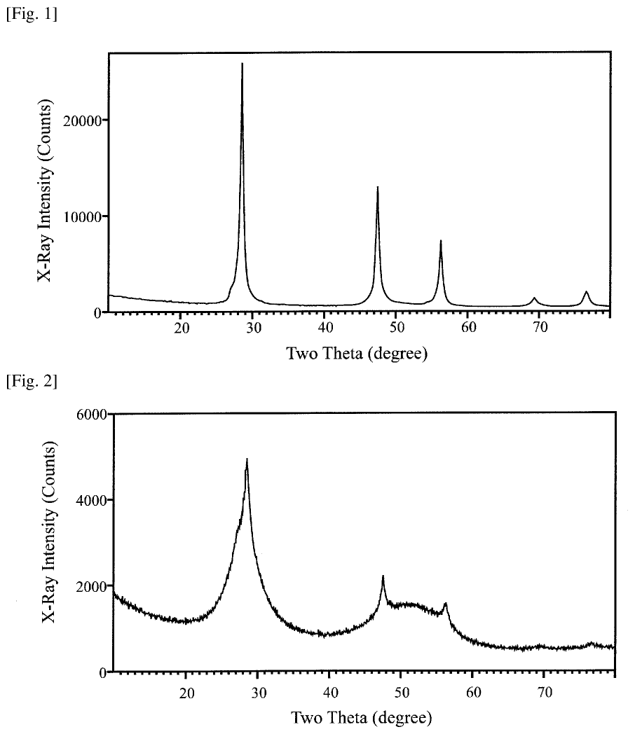

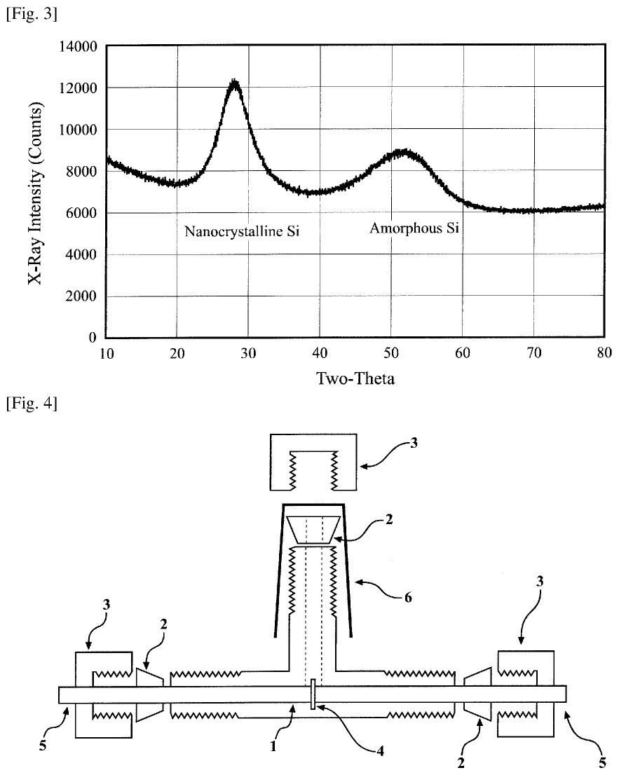

A series of silicon containing compositions were obtained from commercial sources. Polycrystalline silicon was obtained from Alfa Aesar (US), Fijifilm (Japan), Hongwu (China), Silican (Taiwan) and Paraclete (US). Amorphous/nanocrystalline silicon was obtained from Cenate (Norway) and Strem (US). To confirm the microstructure of each of the silicons used, each sample was subjected to analysis by x-ray diffraction (XRD) utilizing a Philips X'Pert Pro x-ray diffractometer with Cu—K_{α} as radiation source. Sample 1 included the polycrystalline Si. A diffraction pattern is illustrated in FIG. 1. The diffraction illustrates sharp peaks at about 480 and 560 which is classically characteristic of polycrystalline silicon. The material does not appear to include any amorphous or nanocrystalline silicon. Sample 2 analyses are illustrated at FIG. 2 and includes a mixture of polycrystalline with nanocrystalline and amorphous silicon. The nanocrystalline is revealed by the broad peak at about 290 and the amorphous present as the broad peak at about 52°. It is clear from the small sharp peaks at about 480 and 560 that some amount of polycrystalline Si is also present in the sample. Sample 3 as depicted in FIG. 3 illustrates a mixture of nanocrystalline Si and amorphous Si in the absence of any polycrystalline Si.

Anodes were constructed from each of the sample silicon containing materials. The Silicon materials were in powder form and combined with a TAB-2 binder in the dry form at a weight ratio of 1:3. The materials were pressed into a Ni mesh substrate as a current collector. Ni(OH)₂ cathodes were made by standard methods using commercially sourced and sintered Ni(OH)₂. To test the electrochemical properties, the anodes were tested by forming an electrochemical cell within an all-teflon Swagelock tee. The cell used for electrochemical analyses is illustrated in FIG. 4 and includes a central gland 1 capped with ferrules 2 at both ends secured by collars 3. The sample 4 is sandwiched between two current collector rods 5 made from Ni-plated steel (NS) or stainless steel (SS). The top channel is covered with a parafilm 6 as a pressure vent device. The sample is a sandwich of an anode, cathode, and separated by a standard separator. The cell is flooded with an electrolyte including EMIM/AC with 3.33 m acetic acid that included one or more salt additives.

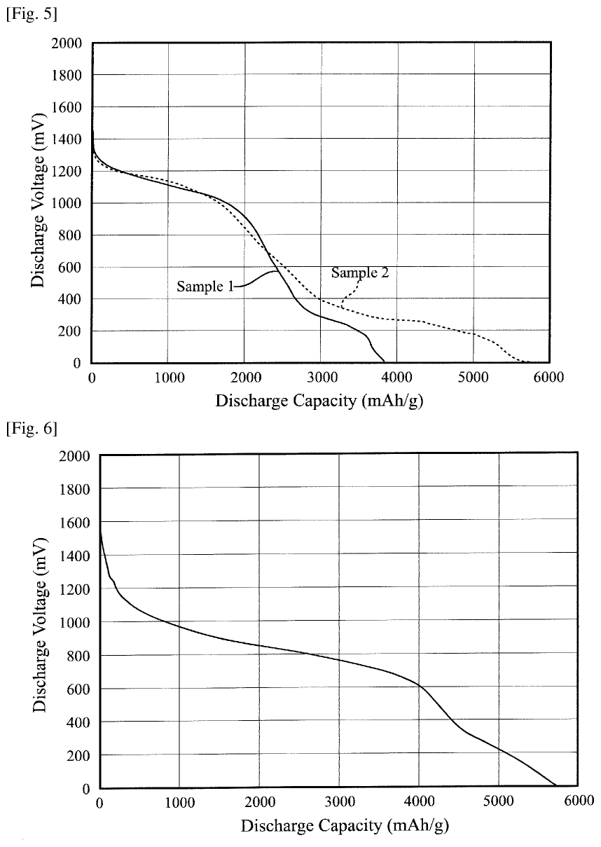

The cell was cycled with a charge rate of 700 mA/g, charge time: 20 hours and a discharge rate of 70 mA/g to a discharge cut-off of 1 V or 0 V. The discharge provides following cell formation at cycle 28 for samples 1 and 2 (FIG. 5), and cycle 31 for sample 3 (FIG. 6) demonstrate high capacity in excess of 3800 mA/g (of Si) for all samples tested. Both the polycrystalline Si anode and the mix of nanocrystalline Si and amorphous Si showed maximum discharge capacity in excess of 5500 mAh/g. Results for all three samples and conditions are illustrated in Table 1.

TABLE 1

| | | | | Maximum Capacity, | Capacity to |
|---|---|---|---|---|---|
| Sample ID | Anode | Salt Additives | | mAh/g | 1V cut-off |
| Sample 1 | Poly-Si | 0.1 | m K₂HPO₄ | 3843 | 1652 |
| Sample 2 | Amorphous/Nano/Poly-Si | 0.1 | m K₂HPO₄ | 5761 | 1754 |
| Sample 3 | Amorphous/Nano -Si | 0.1 | m KHCO₃ | 5767 | 805 |

### Example 2

It was found that the addition of particular salts to an electrolyte of a proton conducting battery employing a Si containing anode could stabilize and improve the formation of the cell and thereby improve the electrochemical characteristics of the cell. The cells of Example 1 are tested with or without the addition of one or more salt additives supplemented into the electrolyte. These studies were done using potassium salts simply due to the ready solubility of potassium salts, but are expected to show similar function for sodium salt additives.

An EMIM/Ac electrolyte including acetic acid at 3.33 m was further tested as is, or through the addition of K₂HPO₄, KH₂PO₄, KHCO₃, KHSO₄, or K₂C₂O₄ at concentrations of 0.1 or 0.05 m. The electrolytes were studied in cells including polycrystalline Si anodes of Sample 1 of Example 1. The cells were charged at 700 mAh/g for 20 hours followed by discharge at 70 mAh/g to a cut-off of 0 V and studied for capacity out to 31 cycles. Results are presented in Table 2.

TABLE 2

| | | Maximum |
|---|---|---|
| Salt Additive | | Capacity, mAh/g |
| None | | 936 |
| 0.1 | m K₂HPO₄ | 6835 |
| 0.05 | m KH₂PO₄ | 5512 |
| 0.1 | m KHCO₃ | 5427 |
| 0.1 | m KHSO₄ | 3059 |
| 0.1 | m K₂C₂O₄ | 4904 |

While excellent maximum capacity is reached in the absent of a salt additive, the cells demonstrated greater than three-fold increases in maximum capacity with the addition of potassium salt additives. The capacity of the cell using the K₂HPO₄ additive showed a remarkable maximum capacity of over 6800 mAh/g of the Si anode material.

The foregoing description of particular aspect(s) is merely exemplary in nature and is in no way intended to limit the scope of the invention as claimed below, its application, or uses, which may, of course, vary. The disclosure is provided with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

In view of the foregoing, it is to be understood that other modifications and variations of the present invention may be implemented. The foregoing drawings, discussion, and description are illustrative of some specific embodiments of the invention but are not meant to be limitations upon the practice thereof. It is the following claims, including all equivalents, which define the scope of the invention.

1. A proton-conducting rechargeable battery comprising:
a cathode comprising a cathode electrochemically active material capable of storing and releasing hydrogen;
an anode, the anode comprising an anode electrochemically active material comprising one or more group 14 elements, the anode electrochemically active material in the powder form and associated by a binder, wherein a microstructure of the anode electrochemically active material is polycrystalline, a mixture of nanocrystalline and amorphous, or a combination of polycrystalline, nanocrystalline and amorphous; and
a non-aqueous electrolyte in between the anode and the cathode;
wherein a discharge capacity of the rechargeable battery is above 800 mAh/g of the anode electrochemically active material above 1 Volt.

2. The battery of claim 1 wherein the anode electrochemically active material comprises two or more group 14 elements.

3. The battery of claim 1 wherein the anode electrochemically active material comprises Si.

4. The battery of claim 1, wherein the anode electrochemically active material comprises Si and one or more non-Si group 14 elements.

5. The battery of claim 4 wherein the one or more non-Si group 14 elements is C, Ge, or combinations thereof.

6. The battery of claim 4 wherein the amount of non-Si group 14 elements is 50 atomic percent or less relative to the total group 14 elements in the anode electrochemically active material.

7. The battery of claim 1, wherein the discharge capacity of the rechargeable battery is above 1000 mAh/g of anode electrochemically active material above 1 Volt vs. Ni(OH)₂ cathode.

8. The battery of claim 1, wherein the maximum discharge capacity of the rechargeable battery is above 3500 mAh/g of anode electrochemically active material.

9. The battery of claim 1, wherein the electrolyte comprises one or more aprotic compounds and acid(s) as proton source.

10. The battery of claim 9 wherein the aprotic compounds comprise 1-butyl-3-methylimidazolium (BMIM), 1-ethyl-3-methylimidazolium acetate (EMIM), 1,3-dimethylimidazolium, 1-ethyl-3-methylimidazolium, 1,2,3-trimethylimidazolium, tris-(hydroxyethyl)methylammonium, or 1,2,4-trimethylpyrazolium.

11. The battery of claim 9 wherein the electrolyte further comprises an additive, the additive comprising potassium, acetic acid, or combinations thereof.

12. The battery of claim 11 wherein the additive is a salt additive comprising phosphate, carbonate, or sulfate of potassium.

13. The battery of claim 1, wherein the anode electrochemically active material further comprises one or more non-group 14 element containing hydrogen storage materials, wherein the non-Si hydrogen storage materials are present at 50 weight percent or less.

14. The battery of claim 1, wherein the cathode electrochemically active material comprises Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, a hydride thereof, an oxide thereof, a hydroxide thereof, an oxyhydroxide thereof, or any combination of the foregoing.

15. The battery of claim 14 wherein the cathode electrochemically active material comprises Ni.

16. The battery of claim 14 wherein the cathode electrochemically active material comprises Ni at greater than or equal to 10 atomic percent relative to all metals in the cathode electrochemically active material.

17. The battery of claim 14 wherein Ni is present at equal to or greater than 80 atomic percent, optionally 90 atomic percent in the metallic content of the cathode electrochemically active material.

18. The battery of claim 14 wherein the cathode electrochemically active material comprises a hydroxide of Ni, Co, Mn, Zn, Al, or combinations thereof.
